(19) United States
(12) Patent Application Publication
(10) Pub. No.: US 2017/0229887 A1
(43) Pub. Date: Aug. 10, 2017

(54) CHARGE ON DEMAND CONTROL SYSTEM

(71) Applicant: Novanta Corporation, Bedford, MA (US)

(72) Inventors: Scott Bentley, Norfolk, MA (US); Scott Oppenheim, Groton, MA (US); John Crabtree, Lexington, MA (US)

(73) Assignee: Novanta Corporation, Bedford, MA (US)

(21) Appl. No.: 15/427,582

(22) Filed: Feb. 8, 2017

Related U.S. Application Data
(60) Provisional application No. 62/292,530, filed on Feb. 8, 2016.

(51) Int. Cl. H02J 7/00

(52) U.S. Cl. CPC H02J 7/0036; H02J 7/007; H02J 7/0045

(57) ABSTRACT

A system for controlling whether a battery powered device tethered to a host via a Universal Serial Bus (USB) interface will charge its battery via the USB connection. A USB interface adapter is programmed to control charging of the device battery based on whether a standard data terminal ready (DTR) signal is received from the host through a USB to RS-232 converter. Data packets are sent via the USB data line and interpreted as a DTR signal by the USB to Serial adapter. The dedicated DTR output pin from the adapter is thus used to control the charging circuit.

### BACKGROUND OF THE INVENTION

1. Field of the Invention

The present invention relates to power charging systems and, more specifically, to a system for controlling when a device battery will be charged.

2. Description of the Related Art

Battery powered devices having a Universal Serial Bus (USB) interface will immediately start to charge whenever power is available through the USB interface. This automatic charging may be undesirable, such as when the host to which the battery powered device in connected is also running from a battery, as the charging of the device will adversely impact the power status of the host. Thus, control of the charging of devices connected via a USB interface can be critical to the host. Accordingly, there is a need in the art for a system that can provide the host with control over whether a slave device is charged via the USB interface.

### BRIEF SUMMARY OF THE INVENTION

The present invention is a system for controlling when a device is charging that includes a USB interface for connecting the device to a host, a first circuit coupled to the USB interface and configured to provide data received from the host via the USB interface to the device, a second circuit coupled the USB interface and configured to selectively allow charging of a battery coupled to the device using power provided via the USB interface or deny charging of the battery via the USB interface, and a third circuit coupled to the first circuit and the second circuit. The third circuit is programmed to control whether the second circuit allows or denies charging of the battery via the USB interface based on receipt of a signal from the host via the USB interface. The first circuit may be a USB universal asynchronous receiver/transmitter. The second circuit may be a single-ended primary inductive converter. The third circuit may be a microprocessor and a switched voltage regulator. The signal triggering whether to allow charging of the battery can be a DTR signal and the microprocessor may be programmed to allow the device to charge via the USB interface when the DTR signal is asserted by the host. In this example, the device may be a printer.

The present invention also includes a method of controlling when a device is charging, comprising the steps of providing a system having a USB interface for connecting the device to a host, a first circuit coupled to the USB interface and configured to provide data received from the host via the USB interface to the device, a second circuit coupled the USB interface and configured to selectively allow charging of a battery coupled to the device using power provided via the USB interface or deny charging of the battery via the USB interface, and a third circuit coupled to the first circuit and the second circuit. The next step involves sending a signal from the host via the USB interface. Finally, the method involves allowing charging of the battery via the USB interface in response to receipt of the signal from the host via the USB interface and denying charging of the battery via the USB interface in response in the absence the signal.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a system for controlling the charging of a device connected to a host via a USB interface; and

FIG. 2 is a flowchart of a method according to the present invention.

### DETAILED DESCRIPTION OF THE INVENTION

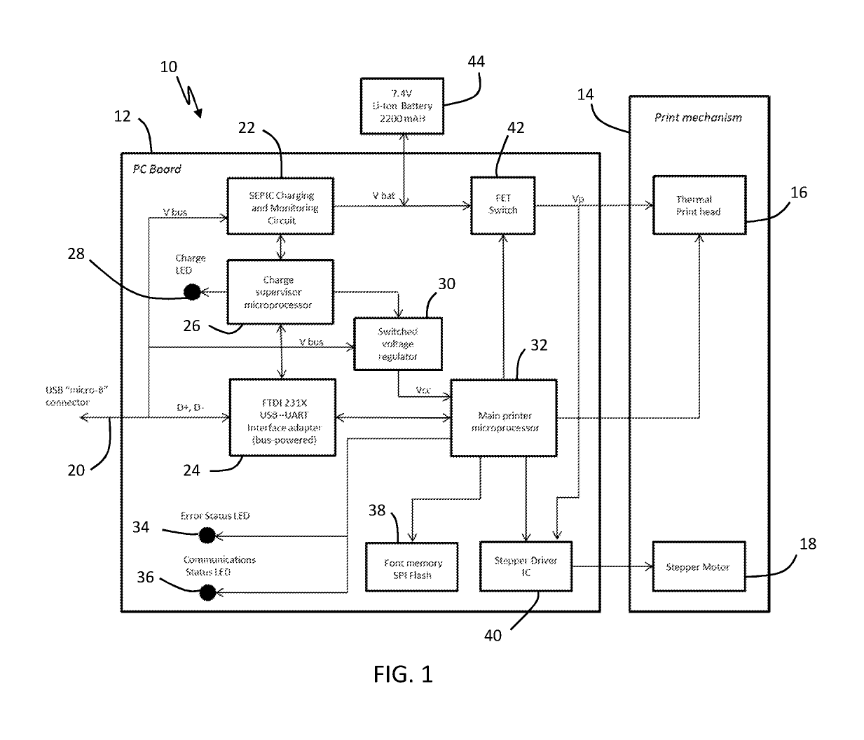

Referring now to the drawings, wherein like reference numerals refer to like parts throughout, there is seen in FIG. 1 a USB device 10 that only charges when authorized to do so via a USB host. Device 10 is illustrated as a printer having a PC board 12 and an associated print mechanism 14 having a thermal print head 16 and a stepper motor 18 as an example. PC board 12 includes USB interface 20 interconnected to a charging and monitoring circuit 22 and a USB interface adapter 24 comprising a USB to serial converter chip with standard serial port control lines for the interface such as a conventional USB universal asynchronous receiver/transmitter (UART). A charge supervisor microprocessor 26 is associated with charging and monitoring circuit 22, such as a single-ended primary inductive converter (SEPIC), and optionally controls a charge LED 28 that provides an indication to a user of the charging state of device 10. Charge supervisor microprocessor 26 is also interconnected to USB interface adapter 24 and a switched voltage regulator 30. The main processor 32 of device 10 is coupled to switched voltage regulator 30 and interface adapter 24 as well as an error status LED 34, a communications status LED 36, a font memory 38, a stepper device chip 40 that controls stepper motor 18. Microprocessor 30 is further interconnected to an FET switch 42 associated with thermal printer head 16. Finally, a battery 44 is coupled to charging and monitoring circuit 22 for powering device 10 and for being charged under the control of charging and monitoring circuit 22.

Device 10 is programmed to only charge battery when a standard data terminal ready (DTR) signal is received from a host connected to device 10 via connector 20. More specifically, the receipt of a DTR signal asserted by the host via interface 20. The presence of a DTR signal is provided by USB interface adapter 24 to the charge supervisor microprocessor 26, which is programmed to operate charging and monitoring circuit 22 so that charging of battery 42 occurs via the existing power line of USB interface 20 only when the DTR signal is received from the host. As a result, the host can control when the device is allowed to draw power through USB interface 20 by selectively providing the DTR signal, thus ensuring that device 10 will only charge when the DTS signal is asserted.

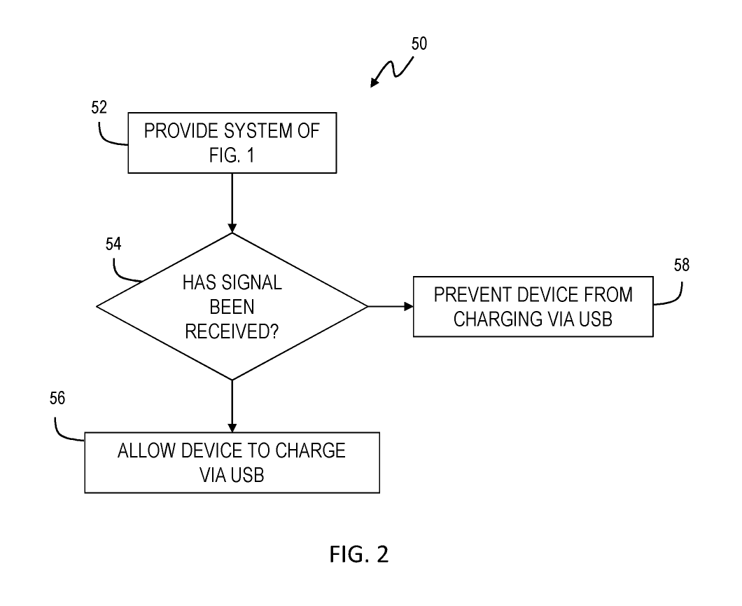

Referring to FIG. 2, a method 50 of controlling charging of a device connected to a USB interface commences with attached a system 10 such as that described above. Next, a check 54 is performed to determine whether the triggering signal has been received from the hose via the USB interface. If so, charging of the battery of device via the USB interface is allowed 56. If not, charging of the battery of device via the USB interface is prevented 58.

The present invention thus provides a system for controlling whether a battery powered device tethered to a host via a USB interface will charge its battery via the USB connection. A USB interface adapter in the device is programmed to control charging of the device battery based on whether a signal, such as a standard data terminal ready (DTR) signal, is received from the host. As a result, the host can control whether the device is allowed to draw power by selectively providing the DTR signal. Data packets are sent via the USB data line that is interpreted as a DTR signal by the USB to Serial adapter. These adapters, which can be made by different manufacturers, provide output pins that emulate the standard RS-232 signals. The adapter manufacturers also provide operating system drivers (windows, Linux, etc.) that allow a programmer to control these lines as if communication with an RS-232 serial port—referred to as Virtual Com Port (VCP) drivers. The dedicated DTR output pin from the adapter is then used to control the charging circuit.

What is claimed is:

1. A system for controlling when a device is charging, comprising:
a universal serial bus (USB) interface for connecting the device to a host;
a first circuit coupled to the USB interface and configured to provide data received from the host via the USB interface to the device;
a second circuit coupled the USB interface and configured to selectively allow charging of a battery coupled to the device using power provided via the USB interface or deny charging of the battery via the USB interface; and
a third circuit coupled to the first circuit and the second circuit, wherein the third circuit is programmed to control whether the second circuit allows or denies charging of the battery via the USB interface based on receipt of a signal from the host via the USB interface.

2. The system of claim 1, wherein the first circuit comprises a USB universal asynchronous receiver/transmitter.

3. The system of claim 2, wherein the second circuit comprises a single-ended primary inductive converter.

4. The system of claim 3, wherein the third circuit comprises a microprocessor and a switched voltage regulator.

5. The system of claim 4, wherein the signal comprises a DTR signal.

6. The system of claim 5, wherein the microprocessor is programmed to allow the device to charge via the USB interface when the DTR signal is asserted by the host.

7. The system of claim 5, wherein the device is a printer.

8. A method of controlling when a device is charging, comprising the steps of:
providing a system having a universal serial bus (USB) interface for connecting the device to a host, a first circuit coupled to the USB interface and configured to provide data received from the host via the USB interface to the device, a second circuit coupled the USB interface and configured to selectively allow charging of a battery coupled to the device using power provided via the USB interface or deny charging of the battery via the USB interface, and a third circuit coupled to the first circuit and the second circuit;
sending a signal from the host via the USB interface; and
allowing charging of the battery via the USB interface in response to receipt of the signal from the host via the USB interface and denying charging of the battery via the USB interface in response in the absence the signal.

9. The method of claim 8, wherein the first circuit comprises a USB universal asynchronous receiver/transmitter.

10. The method of claim 9, wherein the second circuit comprises a single-ended primary inductive converter.

11. The method of claim 10, wherein the third circuit comprises a microprocessor and a switched voltage regulator.

12. The method of claim 11, wherein the signal comprises a DTR signal.

13. The method of claim 12, wherein the microprocessor is programmed to allow the device to charge via the USB interface when the DTR signal is asserted by the host.

14. The method of claim 13, wherein the device is a printer.
